(19) United States
(12) Patent Application Publication
(10) Pub. No.: US 2025/0170959 A1
(43) Pub. Date: May 29, 2025

(54) VEHICULAR EXTERIOR MIRROR ACTUATOR WITH VIBRATION DAMPER

(71) Applicant: Magna Mirrors of America, Inc., Holland, MI (US)

(72) Inventors: James A. Ruse, Allegan, MI (US); Justin E. Sobecki, Rockford, MI (US); Rudy A. Morey, Hudsonville, MI (US)

(21) Appl. No.: 18/951,984

(22) Filed: Nov. 19, 2024

Related U.S. Application Data
(60) Provisional application No. 63/603,307, filed on Nov. 28, 2023.

(51) Int. Cl. B60R 1/072; B60R 1/076

(52) U.S. Cl. CPC B60R 1/072; B60R 1/076

(57) ABSTRACT

A vehicular exterior rearview mirror assembly includes a mounting arm and a mirror head having a mirror reflective element, with a biasing element disposed within the mirror head. An electrically operable actuator is disposed at a distal end of the mounting arm within the mirror head. With the mounting arm attached at the exterior portion of the vehicle, the mirror head is movable relative to the mounting arm and the mirror head is pivotable about a pivot tube of the actuator. The actuator is operable to adjust the mirror head and the reflective element relative to the mounting arm to adjust the rearward view provided to the driver. The biasing element engages the pivot tube and imparts a biasing force between the mirror head and the pivot tube and at least partially attenuates vibrations from transferring through the pivot tube to the mirror head and the reflective element.

### CROSS REFERENCE TO RELATED APPLICATION

The present application claims the filing benefits of U.S. provisional application Ser. No. 63/603,307, filed Nov. 28, 2023, which is hereby incorporated herein by reference in its entirety.

### FIELD OF THE INVENTION

The present invention relates generally to the field of rearview mirror assemblies for vehicles and, more particularly, to an exterior rearview mirror assembly that is operable to adjust a rearward field of view of the driver of the vehicle.

### BACKGROUND OF THE INVENTION

Typically, an exterior rearview mirror assembly includes a mirror actuator that is operable to adjust a mirror reflective element relative to the mirror casing so as to adjust a rearward view of the driver of the vehicle. The reflective element and actuator are disposed in the mirror casing and the actuator adjusts the reflective element relative to the mirror casing. Powerfold exterior mirror assemblies include an actuator disposed at a mounting structure that pivots or folds the mirror casing relative to the side of the vehicle.

### SUMMARY OF THE INVENTION

A vehicular exterior rearview mirror assembly (such as an exterior mirror assembly mounted at a side of an equipped vehicle) includes a mounting arm that includes an attaching end configured for attachment at an exterior portion of a vehicle and a distal end that is distal from the attaching end. A mirror head includes a mirror reflective element and a biasing element is disposed at structure within the mirror head. The distal end of the mounting arm extends or passes through an aperture in the mirror head. An electrically operable actuator is disposed at the distal end of the mounting arm within the mirror head. With the mounting arm attached at the exterior portion of the vehicle, the actuator is electrically operable to adjust the mirror head relative to the mounting arm. When the actuator is electrically operating to adjust the mirror head relative to the mounting arm, the mirror reflective element moves in tandem with the mirror head relative to the mounting arm. With the mounting arm attached at the exterior portion of the vehicle, the mirror head is movable relative to the mounting arm between at least an extended position, where the mirror head is extended outward from a side of the vehicle so that the mirror reflective element is positioned to provide a rearward view at the side of the vehicle to a driver of the vehicle, and a folded position, where the mirror head is moved inward from the extended position toward the side of the vehicle. When the mirror head moves relative to the mounting arm between the extended position and the folded position, the mirror head is adjusted about a pivot tube of the actuator. With the mounting arm attached at the exterior portion of the vehicle, the biasing element engages an upper end of the pivot tube and the biasing element flexes to impart a biasing force between the mirror head and the upper end of the pivot tube. With the biasing element engaging the upper end of the pivot tube, the biasing element at least partially attenuates vibrations from transferring through the pivot tube to the mirror head and the mirror reflective element.

For example, the biasing element may include a spring bar attached to a mirror head bracket or other rigid support structure within the mirror head. The spring bar extends between attachment points of the mirror head bracket with the upper end of the pivot tube disposed between the attachment points. When the spring bar engages the pivot tube, the spring bar flexes and applies a biasing force between the mirror head and the pivot tube. Thus, the spring bar at least partially absorbs or attenuates vibrations from passing between the pivot tube and the mirror head to stabilize or reduce movement of the mirror reflective element as the vehicle is travelling along the road.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with the exterior rearview mirror assembly;

FIG. 2 is a view of the exterior rearview mirror assembly attached at the side of the vehicle.

FIG. 3 is a perspective view of the exterior rearview mirror assembly in the extended position;

FIG. 4 is a perspective view of the exterior rearview mirror assembly in the retracted position;

FIG. 5 is a perspective view of the actuator operable to adjust the exterior rearview mirror assembly at least between the extended position and the retracted position;

FIG. 6 is a perspective view of the exterior rearview mirror assembly with an upper casing portion removed to show the biasing element at the upper end of the pivot tube;

FIG. 7A is a perspective view of the mirror head mounting bracket with the biasing element in an undeflected state;

FIG. 7B is a perspective view of the mirror head mounting bracket with the biasing element in a deflected state;

FIG. 7C is a perspective view of the mirror head mounting bracket comparing the undeflected state and the deflected state of the biasing element;

FIG. 8 is an exploded view of the exterior rearview mirror assembly;

FIG. 9 is sectional view of the exterior rearview mirror assembly; and

FIG. 10 is a diagram showing angular rotation of the mirror head in response to vibrations experienced at the exterior rearview mirror assembly.

### DESCRIPTION OF THE PREFERRED EMBODIMENTS

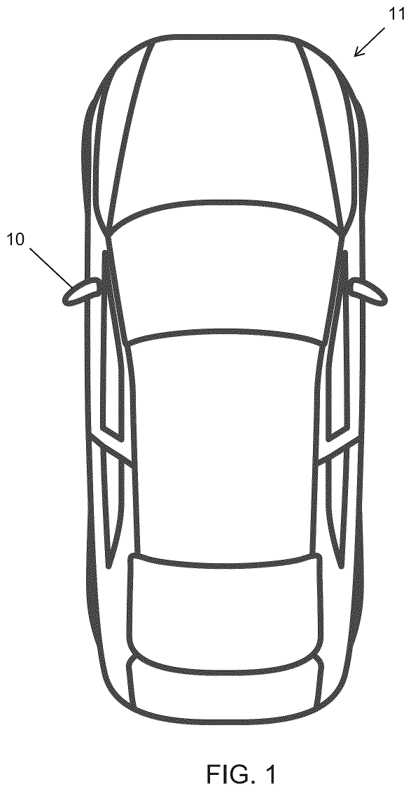

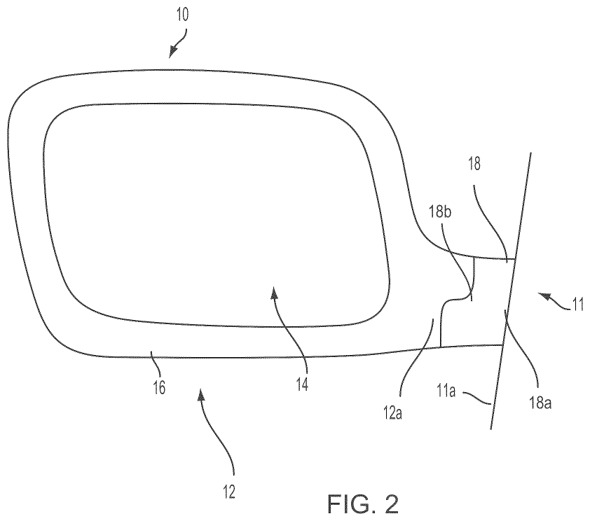

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIGS. 1 and 2). The mirror head portion 12 includes a mounting portion 12a that is pivotally or movably mounted to a mounting arm or base portion 18. The mirror assembly 10 may comprise a powerfold mirror (where the mirror head portion may be pivoted via an actuator assembly or adjustment device), and/or the mirror assembly may comprise a breakaway mirror (where the mirror head portion may be manually pivoted about the mounting arm or base). The mounting arm or base 18 of the mirror assembly 10 is mounted at the side 11a of the vehicle 11, with the reflective element 14 providing a rearward field of view along the respective side of the vehicle 11 to the driver of the vehicle.

The mirror reflective element 14 may be fixedly mounted to the mirror casing 16 such that the mirror reflective element 14 is adjusted together and in tandem with the mirror casing 16 when adjusting the rearward field of view provided by the mirror assembly. For example, the mirror reflective element 14 may be attached to the mirror casing 16 via a head mounting plate 20, which may be disposed at the rear of and attached at a back plate disposed at the rear of the reflective element 14.

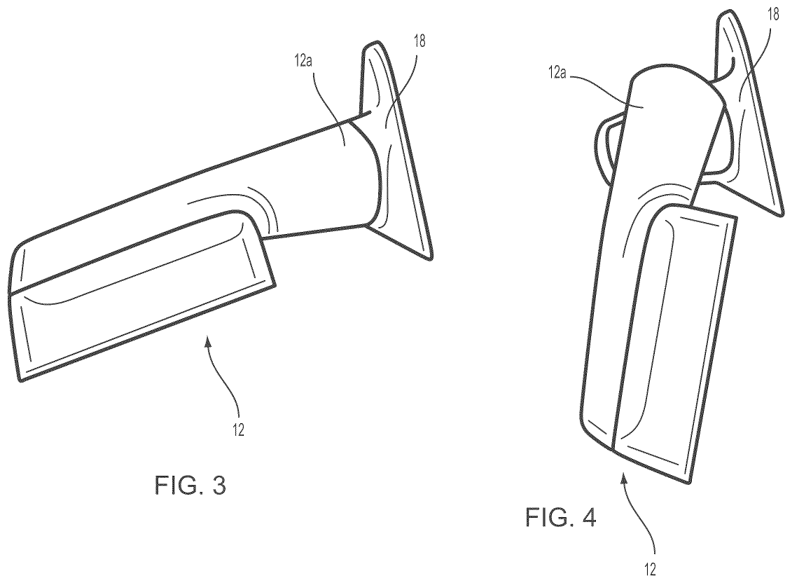

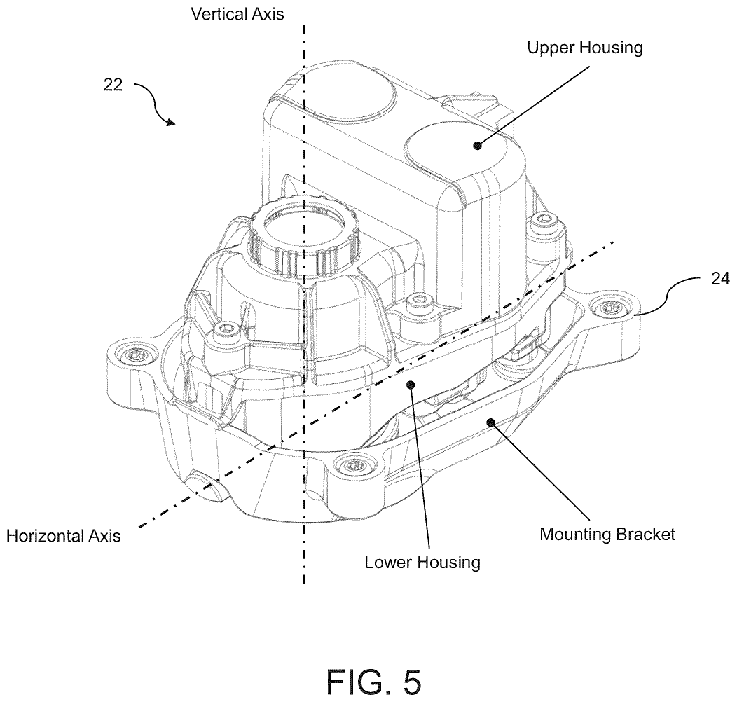

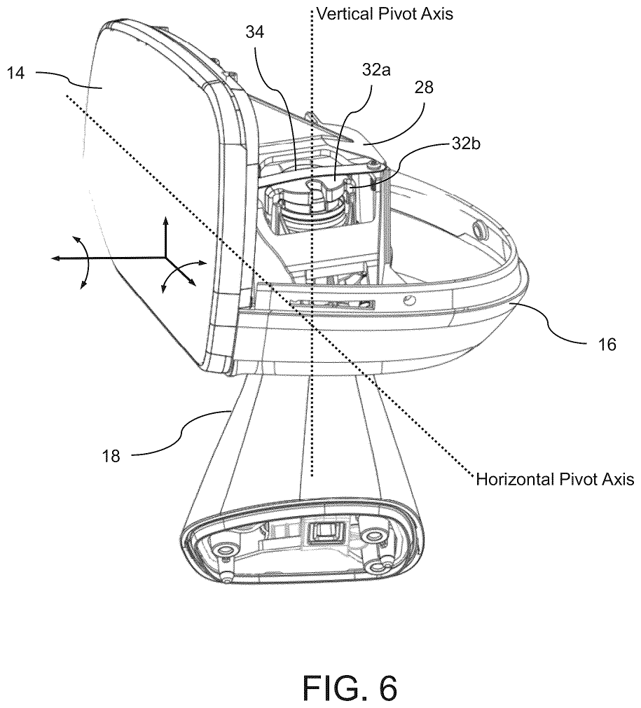

An actuator 22 (FIG. 5) is electrically operable to adjust the mirror head 12 (including the mirror reflective element 14 and the mirror casing 16) relative to the mounting arm 18, and the actuator 22 may be operated to move the mirror head 12 at least between a use or drive position (FIG. 3), where the mirror head 12 is extended relative to the side of the vehicle 11 and the mounting arm 18 to provide the view to the driver of the vehicle rearward and along the side of the vehicle, and a folded or park position (FIG. 4), where the mirror head 12 is folded or pivoted in from the extended position relative to the mounting arm 18 to be disposed along the side of the vehicle 11. Optionally, the mirror head 12 may also be manually pivoted to a fully forward position, where the mirror head 12 is pivoted or rotated beyond the drive position, such as in response to impact of the mirror head 12 with an object. A seal may be disposed along the interface between the mounting portion 12a of the mirror head 12 and the mounting arm 18. With the mirror head 12 in the extended position, the actuator 22 is operable to adjust the mirror head 12 relative to the mounting arm 18 to adjust the rearward field of view provided to the driver of the vehicle. For example, the mirror assembly and actuator 22 may include characteristics of the mirror assemblies described in U.S. Publication No. US-2024-0174178, which is hereby incorporated herein by reference in its entirety.

As shown in FIG. 5, the actuator or pivot assembly 22 allows pivoting of the mirror head 12 about separate horizontal and vertical axes. For example, when the mirror head is pivoted inward or outward relative to the side of the vehicle to adjust the rearward view for the driver of the vehicle, the mirror head 12 may pivot relative to the mounting arm 18 about a generally vertical pivot axis that extends parallel to a plane of the mirror reflective element 14. The mirror head 12 may also pivot about the vertical pivot axis when the mirror head is moved between the extended position and the folded position. When the mirror head is tilted upward or downward to adjust the rearward view for the driver of the vehicle, the mirror head 12 may pivot about a generally horizontal pivot axis that extends parallel to the plane of the mirror reflective element 14 and perpendicular to the vertical pivot axis. The actuator 22 may include an actuator housing that houses or encases separate motors and gear trains to electrically pivot or rotate the mirror head about each axis. That is, electric rotation about each axis is provided by its own respective motor and gear train.

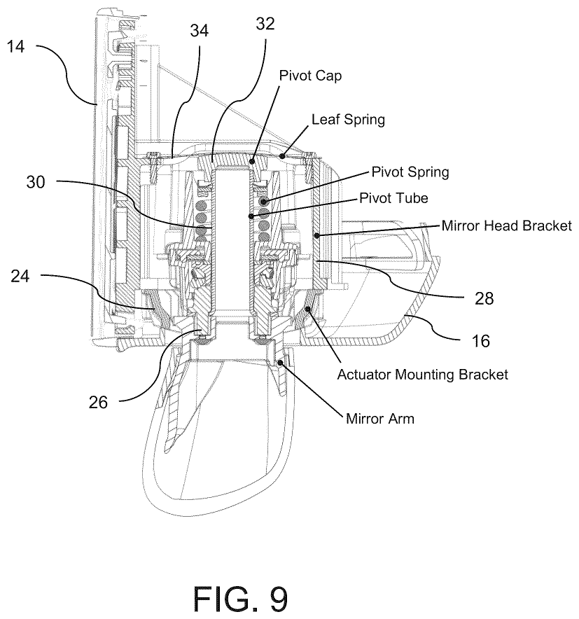

The mirror housing 16 (e.g., a lower portion of the mirror housing 16) attaches to the actuator 22 through a mounting bracket 24. The mounting bracket 24 may be attached to a lower housing portion of the actuator 22 and fixed relative to the actuator 22 about the vertical pivot axis. The mounting bracket 24 pivots relative to the actuator or actuator housing about the horizontal pivot axis. The actuator 22 is also attached to the mounting arm 18, such as via an attachment element or vertical adapter plate 26 (FIG. 9), and the actuator body (upper and lower housing portions and everything within) pivots about the vertical axis pivot relative to the vertical adapter plate 26. Because the mounting bracket 24 is attached to the lower housing of the actuator 22, the mounting bracket 24 and elements or components attached to the mounting bracket (e.g., the mirror head via attachment between the mounting bracket and lower mirror housing) will pivot about the vertical pivot axis when the actuator housing or body pivots about the vertical pivot axis. Thus, the actuator 22 operates to pivot the mounting bracket 24 and the mirror head 12 together and in tandem with one another about the horizontal pivot axis relative to the actuator housing. The actuator 22 operates to pivot the actuator housing, mounting bracket 24, and mirror head 12 together and in tandem with one another about the vertical axis relative to the vertical adapter plate 26 and/or the mounting base 18 at the side of the vehicle. The actuator 22 further allows for manual pivoting of the mirror head about the vertical and horizontal axes via clutch assemblies of the respective gear trains.

With the mirror reflective element 14 fixed relative to the mirror casing 16 and the mirror casing 16 mounted to the mounting arm 18 via the actuator 22, movement of the mirror reflective element 14 is dependent upon the actuator 22. During driving, with the mirror head 12 in the extended position, the mirror reflective element 14 may experience undesirable vibrations, which can interfere with the rearward view provided by the mirror reflective element and may cause the driver to become disoriented when using the mirror to obtain the rearward view. For example, vibrations experienced at the mounting arm 18 may travel through the actuator 22 to the mirror reflective element. This can be due to stiffness of the actuator 22, vehicle door stiffness, mounting constraints, and the like.

Thus, and as described further below, the exterior rearview mirror assembly 10 includes a passive mechanism that provides a damping load and/or a resistive torque to the movement of the mirror head about the horizontal pivot axis (e.g., up/down movement of the mirror head) to eliminate or reduce the magnitude and harshness of undesirable vibrations of the mirror reflective element. This may reduce a “clocking” motion of the mirror glass.

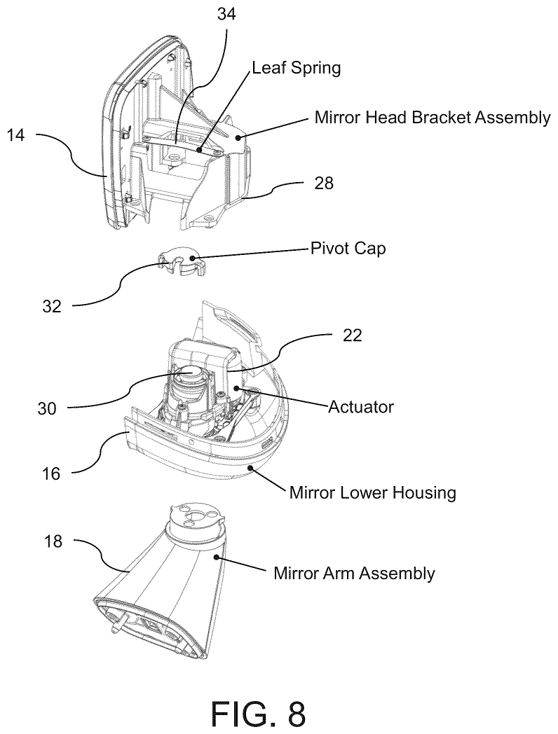

Referring to FIGS. 5-9, the actuator 22 is accommodated within the mirror head 12 at least partially below or underneath a mirror head bracket assembly 28. The mirror head bracket 28 may be attached at or integrally formed with the head mounting plate 20 attached at the back plate of the mirror reflective element 14. In the illustrated example, the mirror head bracket assembly 28 attaches to the mounting bracket 24 attached to the actuator 22, with the actuator housing or body between the mounting bracket 24 and the mirror head bracket 28. In other words, the actuator is accommodated between the mirror head bracket 28 and the mounting bracket 24, with the mirror head bracket 28 and the mounting bracket 24 connected to the mirror reflective element 14 and/or the mirror housing 16. Thus, the mirror head bracket 28 moves together and in tandem with the actuator 22 and mirror head 12 about the vertical pivot axis relative to the mounting arm 18 and the mirror head bracket 28 moves together and in tandem with the mounting bracket 24 and the mirror head 12 about the horizontal pivot axis relative to the mounting arm 18 and the actuator 22.

When the mirror head 12 is pivoted about the vertical pivot axis, the mirror head 12 pivots about a pivot tube 30 of the pivot assembly 22. A pivot cap 32 is disposed at an upper end of the pivot tube 30, such as friction-fit to the top of the pivot tube 30. The pivot cap 32 may be disposed either on the inner or outer diameter of the tube 30. A biasing element 34, such as a spring bar or leaf spring, is disposed at the mirror head bracket 28 and configured to engage an upper or outer surface of the pivot cap 32 to impart a biasing force between the mirror head bracket 28 and the pivot cap 32. Thus, when vibrations or other forces are experienced at the mounting arm 18 (such as while the vehicle travels along the road), the vibrations may be at least partially absorbed or attenuated by the biasing element 34 at the upper end of the pivot tube 30 to preclude or reduce vibrations transferred to the mirror head 12 and the mirror reflective element 14.

In other words, the spring bar 34 is securely mounted to the mirror head bracket 28 or some other rigid structural member within the mirror head assembly rigidly connected to the mirror reflective element 14 and/or mirror housing 16. The spring bar 34 may be attached to the structural member via screws, friction fitting, snap clips, adhesive or any suitable fastener. The spring bar 34 engages a rigid element connected to the mounting arm 18 and flexes relative to the structural member of the mirror head and the rigid element connected to the mounting arm 18 to reduce or preclude vibrations from transferring from the vehicle through the mounting arm 18 to the mirror reflective element 14 and/or mirror housing 16. In the illustrated example, the spring bar 34 extends along and/or across a gap or space in the mirror head bracket 28 to engage the pivot cap 32 within the gap, and the spring bar 34 is supported at both ends via attachment to the mirror head bracket 28. Optionally, the spring bar 34 may be supported at only one end (with the other end free or unsupported) in a cantilever manner. The spring bar 34 may be made of any type of suitable flexible or deformable or spring material, such as hardened steel or elastomeric material that deforms or flexes and that is biased toward its initial or undeformed or undeflected state.

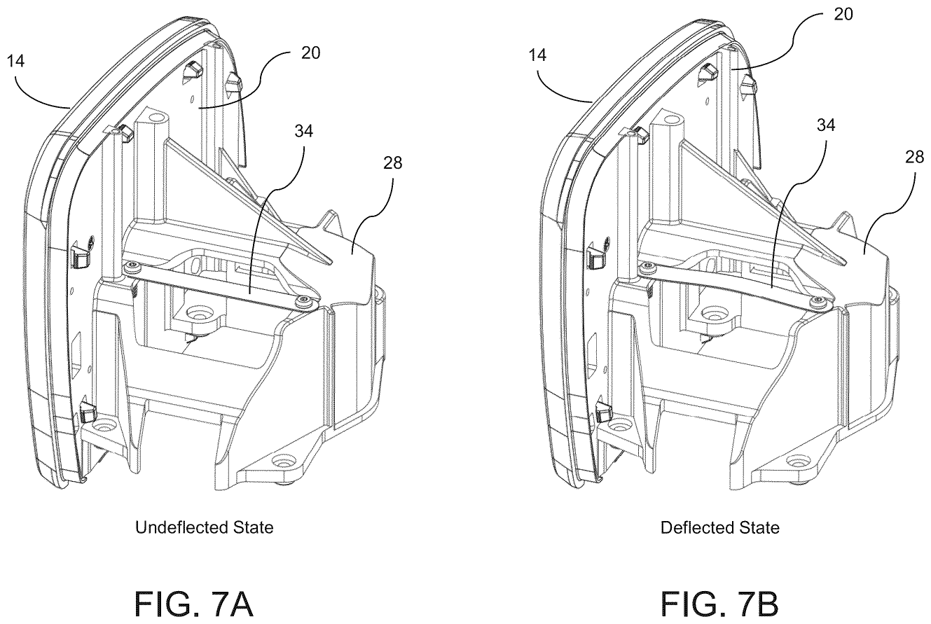

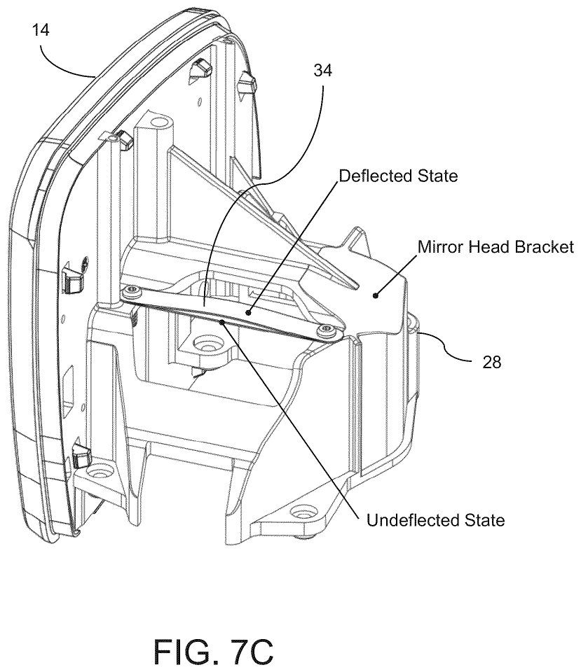

With the spring bar 34 extending along and across and engaging the pivot cap 32, the spring bar is forced to deflect or flex from an undeflected state (FIG. 7A) to a deflected state (FIG. 7B) and is biased toward the undeflected state. This imparts a spring load and a resistive torque on the exterior surface of the pivot cap 32. The resistive torque provided by the spring bar 34 dampens or reduces movement of the mirror head 12 about the horizontal pivot axis. Further, the spring load provided by the spring bar dampens or reduces “clocking” or rotational motion of the mirror head about an axis normal to the horizontal-vertical plane (e.g., the plane of the mirror reflective element) (FIG. 6).

The exterior surface of the pivot cap 32 may have a cylindrical surface that may share a common axis with the horizontal axis of the mirror head. This way, the spring bar 34 maintains the same or similar amount of contact with the pivot cap 32 regardless of the tilt position of the mirror head 12 about the horizontal pivot axis. That is, an upper surface 32a of the pivot cap 32 may be rounded or curved or arcuate to maintain engagement between the spring bar 34 and the upper surface 32a of the pivot cap 32 throughout the range of motion of the mirror head about the horizontal pivot axis. The radius of curvature of the surface 32a may have a center point concentric with the horizontal pivot axis. Moreover, the pivot cap 32 may include wings or tabs 32b extending from opposing sides of the pivot cap 32 and perpendicular to the horizontal pivot axis, with the curved upper surface 32a extending at least partially along the wings 32b to accommodate movement of the spring bar 34 along the cap 32 during tilting of the mirror head. The wings 32b may engage channels or structure of the actuator housing so that the cap 32 rotates with the actuator relative to the pivot tube 30. Because the mirror head 12 may be electrically connected to the vehicle wire harness via wiring extending along the pivot tube 30, the pivot cap 32 may include a slot for allowing the mirror wire harness to pass through the pivot cap 32.

Thus, the mirror assembly 10 includes the spring bar 34 that applies a biasing force between a structural component of the mirror head 12 and the pivot tube 30 to absorb or attenuate vibrations and other forces from transferring from the vehicle 11 through the pivot tube 30 to the mirror head 12. With the mirror head 12 in the extended position, the spring bar 34 resists movement of the mirror bracket 28 and thus mirror casing 16 and mirror reflective element 14 relative to the pivot tube 30 and mounting arm 18. This provides added stability to the mirror head 12 and may reduce wear on other components of the mirror head (e.g., detent interfaces of the actuator). Further, the added stability improves the view provided to the driver of the vehicle.

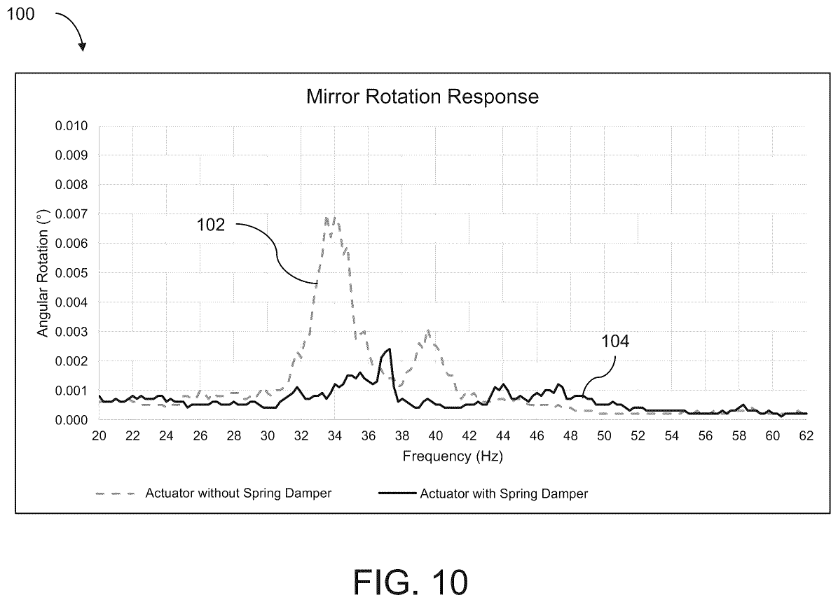

FIG. 10 shows a chart 100 depicting vibration performance at a mirror head having the actuator with the vibration damper and at a mirror head having the actuator without the vibration damper. Line 102 represents movement of the mirror head (angular rotation in degrees, as shown along the y-axis) responsive to vibration experienced at the mirror head (frequency in hertz, as shown along the x-axis) with the actuator that does not include the vibration damper. Line 104 represents movement of the mirror head responsive to vibration, with the actuator that does include the vibration damper. As shown, the vibration damper significantly reduces movement of the mirror head responsive to vibrations experienced at the mirror head at most frequencies.

The mirror assembly may utilize aspects of the mirror assemblies described in U.S. Publication Nos. US-2023-0009664; US-2021-0331625; US-2021-0316664; US-2020-0353867 and/or US-2020-0223364, and/or U.S. Pat. Nos. 11,351,919; 11,325,535; 10,099,618; 9,827,913; 9,487,142; 9,346,403 and/or 8,915,601, which are all hereby incorporated herein by reference in their entireties.

Optionally, the reflective element may comprise a frameless reflective element, such as the types shown and/or described in U.S. Des. Pat. Nos. U.S. Pat. Nos. 7,253,723; 8,154,418; 8,508,831; 8,730,553; 9,598,016 and/or 9,346,403, and/or U.S. Publication Nos. US-2014-0313563 and/or US-2015-0097955, which are hereby incorporated herein by reference in their entireties. In such an application, the mirror reflective element may have a rounded or ground perimeter edge region at its periphery of the front surface, and such a rounded or ground or polished perimeter edge region of the glass substrate of the reflective element may be exposed to, contactable by and/or viewable by the driver of the vehicle and may comprise a polished perimeter that is polished to a water-clear finish and may have a radius of curvature of at least about 2.5 mm. The rounded perimeter edge of the glass substrate of the mirror reflective element may provide a generally smooth or continuous transition from the generally planar (or slightly curved) front surface of the mirror reflective element to the outer surface of the mirror head or mirror casing at which the mirror reflective element is mounted. Optionally, the mirror reflective element may have a thin or very thin bezel at the perimeter region of the front surface of the reflective element, and optionally, the mirror reflective element may have a clear bezel at the perimeter region of the front surface of the reflective element, or the like, depending on the particular application of the mirror assembly and the desired appearance and/or styling of the mirror assembly.

Optionally, other mirror designs or configurations may be contemplated, such as various configurations of the mirror casing and reflective element and any bezel at the mirror reflective element. Optionally, the mirror casing (or separate bezel portion of the mirror casing) may circumscribe the periphery of the mirror reflective element to provide a generally smooth or continuous transition from the generally planar (or slightly curved) front surface of the mirror reflective element to the outer surface of the mirror head or mirror casing at which the mirror reflective element is mounted. For example, the mirror casing may comprise a plastic molding (such as formed via injection molding of a polymeric material) that comprises a portion that (a) abuts a circumferential edge of the mirror glass substrate (such as the front glass substrate of an electrochromic mirror reflective element or a glass prism of a prismatic mirror reflective element) and (b) has an outer curved surface that extends from generally adjacent to a first surface of the glass substrate and that may lack a sharp edge, and that does not encroach onto the outer glass first surface of the glass substrate, such as described in U.S. Pat. Nos. 7,255,541; 7,289,037; 7,360,932; 8,049,640 and/or 8,529,108, which are hereby incorporated herein by reference in their entireties. Optionally, the mirror assembly may include a conventional bezel, such as described in U.S. Pat. No. 7,224,324, which is hereby incorporated herein by reference in its entirety.

The exterior rearview mirror assembly may include a casing, such as described above, or the mirror assembly may comprise or utilize aspects of other types of casings or the like, such as described in U.S. Pat. Nos. 7,338, 177; 7,289,037; 7,249,860; 6,439,755; 4,826,289 and/or 6,501,387, which are all hereby incorporated herein by reference in their entireties. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, and/or in U.S. Pat. Pub. Nos. US-2006-0061008 and/or US-2006-0050018, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mounting arm comprising (i) an attaching end configured for attachment at an exterior portion of a vehicle equipped with the vehicular exterior rearview mirror assembly and (ii) a distal end that is distal from the attaching end;
a mirror head comprising a mirror reflective element;
wherein the distal end of the mounting arm passes through an aperture of the mirror head;
an electrically operable actuator disposed at the distal end of the mounting arm within the mirror head;
wherein, with the mounting arm attached at the exterior portion of the vehicle, the mirror head is movable relative to the mounting arm to provide for a driver of the vehicle a rearward view at a side of the vehicle;
wherein, with the mounting arm attached at the exterior portion of the vehicle, the mirror head is pivotable about a pivot tube of the actuator to adjust the mirror head relative to the mounting arm;
wherein, with the mounting arm attached at the exterior portion of the vehicle, the actuator is electrically operable to adjust the mirror head relative to the mounting arm, and wherein, when the actuator is electrically operating to adjust the mirror head relative to the mounting arm, the mirror reflective element moves in tandem with the mirror head relative to the mounting arm to adjust the rearward view provided to the driver of the vehicle;
a biasing element disposed within the mirror head, wherein the biasing element (i) extends from structure of the mirror head and (ii) engages an upper end of the pivot tube;
wherein, with the mounting arm attached at the exterior portion of the vehicle, the biasing element imparts a biasing force between the structure of the mirror head and the upper end of the pivot tube; and
wherein, with the mounting arm attached at the exterior portion of the vehicle, and with the biasing element engaging the upper end of the pivot tube and imparting the biasing force between the structure of the mirror head and the upper end of the pivot tube, the biasing element attenuates vibrations from transferring through the pivot tube to the structure of the mirror head and the mirror reflective element.

2. The vehicular exterior rearview mirror assembly of claim 1, wherein a cap is disposed at the upper end of the pivot tube, and wherein the biasing element engages the cap at the upper end of the pivot tube.

3. The vehicular exterior rearview mirror assembly of claim 2, wherein the cap is friction-fit to one selected from the group consisting of (i) an inner surface of the pivot tube and (ii) an outer surface of the pivot tube.

4. The vehicular exterior rearview mirror assembly of claim 2, wherein the cap comprises a slot, and wherein, with the mounting arm attached at the exterior portion of the vehicle, a wire harness extends from the pivot tube through the slot of the cap into the mirror head.

5. The vehicular exterior rearview mirror assembly of claim 2, wherein the cap comprises a curved upper surface, and wherein the biasing element engages the curved upper surface of the cap.

6. The vehicular exterior rearview mirror assembly of claim 5, wherein a first pivot axis of the mirror head is parallel with a longitudinal axis of the pivot tube, and wherein the actuator is electrically operable to adjust the mirror head about a second pivot axis that is perpendicular to the first pivot axis, and wherein the curved upper surface of the cap comprises a radius of curvature that is concentric with the second pivot axis.

7. The vehicular exterior rearview mirror assembly of claim 1, wherein the biasing element comprises a spring bar that extends at least partially along the upper end of the pivot tube and that flexes to impart the biasing force.

8. The vehicular exterior rearview mirror assembly of claim 7, wherein the spring bar comprises (i) a first end that is attached at the structure of the mirror head and (ii) a second end that is distal from the first end, and wherein the structure is attached at the mirror reflective element, and wherein an intermediate portion of the spring bar between the first end and the second end engages the upper end of the pivot tube.

9. The vehicular exterior rearview mirror assembly of claim 8, wherein the second end of the spring bar is attached at structure of the mirror head that is spaced from the mirror reflective element, and wherein the structure that is attached at the mirror reflective element and the structure that is spaced from the mirror reflective element move in tandem with the mirror head and relative to the pivot tube when the actuator electrically operates to adjust the mirror head relative to the mounting arm.

10. The vehicular exterior rearview mirror assembly of claim 1, wherein, with the mounting arm attached at the exterior portion of the vehicle, the mirror head is movable relative to the mounting arm between at least (i) an extended position where the mirror head is extended outward from a side of the vehicle so that the mirror reflective element is positioned to provide the rearward view and (ii) a folded position where the mirror head is moved inward from the extended position toward the side of the vehicle.

11. The vehicular exterior rearview mirror assembly of claim 10, wherein, when the mirror head moves relative to the mounting arm between the extended position and the folded position, the mirror head is adjusted about a first pivot axis that is parallel with a longitudinal axis of the pivot tube, and wherein, with the mirror head in the extended position and when the actuator is electrically operated to adjust the rearward view, the actuator adjusts the mirror head about the first pivot axis or about a second pivot axis that is perpendicular to the first pivot axis.

12. The vehicular exterior rearview mirror assembly of claim 11, wherein the actuator comprises (i) a first electrically operable motor that is electrically operable to adjust the mirror head about the first pivot axis and (ii) a second electrically operable motor that is electrically operable to adjust the mirror head about the second pivot axis.

13. The vehicular exterior rearview mirror assembly of claim 11, wherein, with the mounting arm attached at the exterior portion of the vehicle, the first pivot axis comprises a vertical pivot axis and the second pivot axis comprises a horizontal pivot axis.

14. The vehicular exterior rearview mirror assembly of claim 1, wherein the aperture allows for movement of the mirror head relative to the mounting arm.

15. A vehicular exterior rearview mirror assembly, the vehicular exterior rearview mirror assembly comprising:
a mounting arm comprising (i) an attaching end configured for attachment at an exterior portion of a vehicle equipped with the vehicular exterior rearview mirror assembly and (ii) a distal end that is distal from the attaching end;
a mirror head comprising a mirror reflective element;
wherein the distal end of the mounting arm passes through an aperture of the mirror head;
an electrically operable actuator disposed at the distal end of the mounting arm within the mirror head;
wherein, with the mounting arm attached at the exterior portion of the vehicle, the mirror head is movable relative to the mounting arm to provide for a driver of the vehicle a rearward view at a side of the vehicle;
wherein, with the mounting arm attached at the exterior portion of the vehicle, the mirror head is pivotable about a pivot tube of the actuator to adjust the mirror head relative to the mounting arm, and wherein a cap is disposed at an upper end of the pivot tube;
wherein, with the mounting arm attached at the exterior portion of the vehicle, the actuator is electrically operable to adjust the mirror head relative to the mounting arm, and wherein, when the actuator is electrically operating to adjust the mirror head relative to the mounting arm, the mirror reflective element moves in tandem with the mirror head relative to the mounting arm to adjust the rearward view provided to the driver of the vehicle;
a biasing element disposed within the mirror head, wherein the biasing element (i) extends from structure of the mirror head and (ii) engages the cap at the upper end of the pivot tube;
wherein the biasing element comprises a spring bar that extends at least partially along the upper end of the pivot tube, and wherein, with the mounting arm attached at the exterior portion of the vehicle, the spring bar flexes to impart a biasing force between the structure of the mirror head and the upper end of the pivot tube; and
wherein, with the mounting arm attached at the exterior portion of the vehicle, and with the spring bar engaging the cap at the upper end of the pivot tube and imparting the biasing force between the structure of the mirror head and the upper end of the pivot tube, the biasing element attenuates vibrations from transferring through the pivot tube to the structure of the mirror head and the mirror reflective element.

16. The vehicular exterior rearview mirror assembly of claim 15, wherein the cap comprises a curved upper surface, and wherein the spring bar engages the curved upper surface of the cap.

17. The vehicular exterior rearview mirror assembly of claim 16, wherein a first pivot axis of the mirror head is parallel with a longitudinal axis of the pivot tube, and wherein the actuator is electrically operable to adjust the mirror head about a second pivot axis that is perpendicular to the first pivot axis, and wherein the curved upper surface of the cap comprises a radius of curvature that is concentric with the second pivot axis.

18. The vehicular exterior rearview mirror assembly of claim 15, wherein the spring bar comprises (i) a first end that is attached at the structure of the mirror head and (ii) a second end that is distal from the first end, and wherein the structure is attached at the mirror reflective element, and wherein an intermediate portion of the spring bar between the first end and the second end engages the cap at the upper end of the pivot tube.

19. A vehicular exterior rearview mirror assembly, the vehicular exterior rearview mirror assembly comprising:
a mounting arm comprising (i) an attaching end configured for attachment at an exterior portion of a vehicle equipped with the vehicular exterior rearview mirror assembly and (ii) a distal end that is distal from the attaching end;
a mirror head comprising a mirror reflective element;
wherein the distal end of the mounting arm passes through an aperture of the mirror head;
an electrically operable actuator disposed at the distal end of the mounting arm within the mirror head;
wherein, with the mounting arm attached at the exterior portion of the vehicle, the mirror head is movable relative to the mounting arm to provide for a driver of the vehicle a rearward view at a side of the vehicle;
wherein, with the mounting arm attached at the exterior portion of the vehicle, the mirror head is movable relative to the mounting arm between at least (i) an extended position where the mirror head is extended outward from a side of the vehicle so that the mirror reflective element is positioned to provide the rearward view and (ii) a folded position where the mirror head is moved inward from the extended position toward the side of the vehicle;
wherein, with the mounting arm attached at the exterior portion of the vehicle, the mirror head is pivotable about a pivot tube of the actuator to adjust the mirror head relative to the mounting arm;
wherein, with the mounting arm attached at the exterior portion of the vehicle, the actuator is electrically operable to adjust the mirror head relative to the mounting arm, and wherein, when the actuator is electrically operating to adjust the mirror head relative to the mounting arm, the mirror reflective element moves in tandem with the mirror head relative to the mounting arm to adjust the rearward view provided to the driver of the vehicle;
wherein, when the mirror head moves relative to the mounting arm between the extended position and the folded position, the mirror head is adjusted about a first pivot axis that is parallel with a longitudinal axis of the pivot tube, and wherein, with the mirror head in the extended position and when the actuator is electrically operated to adjust the rearward view, the actuator adjusts the mirror head about the first pivot axis or about a second pivot axis that is perpendicular to the first pivot axis;
wherein a cap is disposed at an upper end of the pivot tube, and wherein the cap comprises a curved upper surface, and wherein the curved upper surface of the cap comprises a radius of curvature that is concentric with the second pivot axis;
a biasing element disposed within the mirror head, wherein the biasing element (i) extends from structure of the mirror head and (ii) engages the curved upper surface of the cap at the upper end of the pivot tube;
wherein, with the mounting arm attached at the exterior portion of the vehicle, the biasing element imparts a biasing force between the structure of the mirror head and the upper end of the pivot tube; and
wherein, with the mounting arm attached at the exterior portion of the vehicle, and with the biasing element engaging the cap at the upper end of the pivot tube and imparting the biasing force between the structure of the mirror head and the upper end of the pivot tube, the biasing element attenuates vibrations from transferring through the pivot tube to the structure of the mirror head and the mirror reflective element.

20. The vehicular exterior rearview mirror assembly of claim 19, wherein the cap comprises a slot, and wherein, with the mounting arm attached at the exterior portion of the vehicle, a wire harness extends from the pivot tube through the slot of the cap into the mirror head.

21. The vehicular exterior rearview mirror assembly of claim 19, wherein the biasing element comprises a spring bar that extends at least partially along the upper end of the pivot tube and that flexes to impart the biasing force.

22. The vehicular exterior rearview mirror assembly of claim 19, wherein the actuator comprises (i) a first electrically operable motor that is electrically operable to adjust the mirror head about the first pivot axis and (ii) a second electrically operable motor that is electrically operable to adjust the mirror head about the second pivot axis.
